(19) United States
(12) Patent Application Publication
(10) Pub. No.: US 2005/0097733 A1
(43) Pub. Date: May 12, 2005

(54) Device for screwing in magazine-fed fastening elements

(76) Inventors: Daniel Gasser, Diepoldsau (CH); Richard Sahli, Widnau (CH)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/466,647

(22) PCT Filed: Jan. 21, 2002
(86) PCT No.: PCT/EP02/00537

(30) Foreign Application Priority Data
Jan. 22, 2001 (DE) 10102694.3
Jan. 22, 2001 (DE) 101027028

(51) Int. Cl. B30B 1/00; B30B 1/42

(52) U.S. Cl. 29/809

(57) ABSTRACT

The invention relates to a device for screwing in magazine-fed fastening elements that comprises, inter alia, a plastic retainer (13). Between the magazine for the plastic retainers (13) and feeding elements (10) for feeding the plastic retainers (13) to the position of screwing, a picking system (16) is provided. Said picking system (16) is configured by a lever (17) that can be swiveled about an axis (19). An extension (26) that is formed on the lever arm (21) and a stop element (23) that is formed on the lever arm (20) and that can be pushed back against the force of a spring engage in the feed channel (22) alternately and sometimes also at the same time.

The invention relates to an apparatus of the kind defined in the preamble of patent claim 1.

Apparatus of the above-mentioned kind is already known in various configurations, e.g. from (European Patent Publication) EP 0 600 285 A1. In some of these known apparatuses the plastic holders are supplied in a magazine in such a manner that their edges overlap. Therefore, there must be provided an individual element picking device fitted specifically to this particular kind of supply, while there also exists the risk in such a supply that the plastic holders will jam up due to the overlappings and the diagonal position.

In an apparatus of the kind defined in the preamble of patent claim 1, which is known from (German Patent Publication) DE 195 25 328 A1, no specific individual element picking apparatus is provided. Rather, the individual picking is performed by the screwing device itself during the screwing in process. The disadvantage that the plastic holders mutually overlap is avoided in this apparatus by using a belt. This is costly and should also be avoided. However, in this apparatus individual element picking could not take place without the belt.

Apparatus similar to the type mentioned at the outset is known from (German Patent Publication) DE 195 38 812 A1. In this known apparatus the plastic holders are supplied in a magazine so that they overlap in their edge regions. Therefore, there must be provided individual element picking devices which are specifically fitted to this particular kind of supply, while there further exists the risk in such a supply that the plastic holders jam up due to the overlappings and the diagonal positioning.

In such an apparatus, there are also usable various structural forms for the supply of the plastic holders via the magazine. Normally these are appropriate guide rails or guide rods. Also two or more such rails serving as magazine could be located next to each other in the apparatus, wherein through lateral displacement of these magazines, one of the several magazines provided would be ready for the withdrawal of the plastic holders.

The present invention has the object of providing an optimum individual picking device for plastic holders in whose supply their large area washers lie essentially in a common plane.

This object is achieved in accordance with the invention by an apparatus with the characterizing features set forth in patent claim 1.

Thus there is produced an optimum individual picking capability for plastic holders so that these can be supplied with their large area washers essentially in a single plane, so that the tubular extensions lie parallel to each other and are oriented essentially perpendicular to the supply channel. The individual picking is thereby optimally provided, because the lowest plastic holder is prevented from further advance by the lever arm which is inserted there. As soon as an additional plastic holder is to be post-supplied, the lever must be appropriately swiveled away so that the lowest lying plastic holder can slide into the screwing in position. In order to make sure in a simple and effective manner that the next following plastic holder cannot follow immediately, i.e. moves farther along only when the swivelable lever has again returned to its rest position, the spring loaded rearwardly pushable abutment is simply pushed against the surface of the large area washer of the plastic holder, whereby this one and also all following plastic holders in the magazine are prevented from further displacement. After the lever arm has swiveled back to its rest position, the one lever arm is again in the position engaging the supply channel and therefore forms a corresponding abutment for the lowest of the plastic holders which now slide behind it.

A preferred embodiment provides that the spring loaded rearwardly pushable abutment part of the one lever arm takes the form of a bolt which is spring loaded, slidable into its rest position. In this way, even a slight swiveling of the lever can exert pressure against the rear of the plastic holder and this pressure increases correspondingly during further swiveling of the lever. Thus it is always assured that all the stored plastic holders except for the plastic holder at the very bottom are maintained in a blocked condition until the lever returns again to its rest position, with the extension which engages the supply channel blocking further advance.

In a further embodiment of the invention, in its extended rest position the abutment part lies with its free end oriented toward the supply channel until just before engagement in the supply channel, so that this abutment part engages the supply channel even after only a slight turning of the lever. This assures that the plastic holders, with the exception of the lowest plastic holder which is about to be freed up, are secured in a stopped position both during the return swiveling process—i.e. to free up the lowest plastic holder—as well as during rotation of the lever into the rest position—i.e. after the lowest plastic holder has left the magazine area—by means of the engaged spring loaded abutment part in a holding position. Only when the lever is led completely into its rest position, so that the locking extension completely engages the supply channel, there is released the spring loaded rearward pushable abutment, in this case in the form of a bolt, so that now all those plastic holders which still remain in the magazine can slide downwardly past this one station.

In this connection, it is desirable that the distance between the fixed extension and the spring loaded outwardly slidable abutment be greater than the width of the large area washer of the plastic holder, measured in the supply direction of the supply channel, so that at the start of the swiveling movement of the lever and as long as the extension on the other lever arm frees up the passage in the supply channel, the abutment presses against the upper surface of the next following plastic holder. This makes possible the optimum matching of the individual picking device with the plastic holders which are utilized, so that there is assured a trouble free supply and picking motion even during rough use at construction sites.

If, in a further embodiment of the invention, the abutment is rounded and/or tapered at its free end, this provides a correspondingly cleaner and free edge compression area so that there will be no surface damage to the plastic holders.

Provision is further made that the lever is held spring loaded in its rest position, in which the extension engages the supply channel with the lever arm lying at the rear in the supply direction. Thus one speaks of a rest position when the abutment is relieved of pressure so that no compression force is exerted upon the plastic holders. In this rest position, the extension at the lower lever arm has only the purpose of maintaining in this rest position all those plastic holders which lie above it in the magazine, until the next individual picking takes place.

A further structural embodiment contemplates that the lever has a contact surface on a side facing away from the extension and the abutment for applying an actuating element which is slidable in conjunction with the advance of the device. This makes possible, in simple manner as a function of the consecutive setting moves and individual pickings of the plastic holders and preferably plastic holders which are previously provided with premounted screws. In each setting process, i.e. when a fastening element available from storage is screwed in, during return of the device into the starting position, there occurs the supply of an additional fastening element, consisting of plastic holder and screw, with optimum individual picking and supply being achieved by mutual coordination of the movements.

To enable effective and rapid swiveling of the lever of the individual picking device and with it the pressing of the abutment and the freeing up of the lowest plastic holder in optimum mutual coordination, the bearing surface of the lever and a bearing surface of the actuating element in their respective rest positions should have confronting diagonal surfaces which directly contact each other when sliding relative to one another. The two mutually contacting diagonal surfaces cause rapid swiveling of the lever in response to a short movement of the setting apparatus and thus the immediate release of the lowest positioned plastic holder and immediate retention of the lowest plastic holder of those plastic holders which remain above within the magazine.

Especially in such a structural embodiment of an individual picking device, it is preferred that there be applied to it a magazine for the prestorage of plastic holders. In so doing, it is also possible to provide a detachable magazine which can be attached directly to the assembled individual picking device. In such a case it is also possible that the supply elements leading to the screwing in location serve only as a support element because, on this short path leading to the screwing in location, no change in position of the plastic holder remains possible, especially if a plastic holder is already preassembled with a screw, because the center of gravity of the whole fastening element, which lies deep inside the extension of the plastic holder, assures positional maintenance.

An optimum way to keep the plastic holder ready in storage, enabling the simple introduction of the plastic holders and their trouble free withdrawal, is to bound the interior of the supply channel profile by a guide rod and guide rails, with the guide rails being located spaced apart on both sides of the open area.

In such a magazine, the large area washers of the plastic holders can be received lying next to each other oriented in a single plane, so that they rest touching at their edges. Thus the individual plastic holders cannot jam up. Of course the plastic holders are accumulated with an appropriate amount of play, but the arrangement of guide rod or guide rails provides support for the large area washer only in partial areas. No friction losses occur during consecutive sliding of the plastic holders in this magazine because the plastic holders do not contact the magazine over a large area. At the guide rails, there exists only line contact between plastic holder and magazine. At the guide rod which lies in the middle of the supply channel, there is also only small area contact because the plastic holders are provided in the middle of their tops with a large hole which leads into the tubular extension.

In an especially preferred embodiment, the magazine-forming profile is mounted in plug-in and lockable fashion. This makes it possible to provide two or more such magazines which can be continuously refilled, so that, by simply exchanging one magazine at a time, an appropriate quantity of plastic holders is available for further processing in the system. Thus, for filling a magazine, the device itself does not need to be available, but the device can be used during this time to perform settings of the prepared fastening elements, during which time someone else can reequip the available magazines with plastic holders and optionally premounted screws.

In this connection, it is especially preferred that there be formed on the guide rod or the guide rails, recesses or projections which correspond to projections or recesses in the device. Thus the magazine can be attached simply by plugging in, so that the appropriate orientation of the magazine to the apparatus is immediately assured and turning of the magazine about its axis is prevented. The simplest is to provide for this purpose a plug-and-hole connection between magazine and apparatus which makes possible rapid attachment by a kind of coupling-together, whereby both the axial orientation of the magazine as also the appropriate angular position are given precise orientation.

In connection with the coupling between magazine and apparatus, a preferred technique is to provide, for assured positioning and positive locking between magazine and apparatus, an attachment bracket on the back of the magazine for engagement and forcible locking to the apparatus. If the magazine is applied with its lower end interlocking with the apparatus, then, in order to hold the magazine which has, after all, a certain length, in precise orientation to the apparatus, an additional retaining means is still needed. A very simple structural modification is then available for the interlocking latching at a distance from the free end region of the magazine.

In this regard, a preferred technique exists when the magazine has at both end regions closing elements for the loss-preventing retention of inserted plastic holders. Thus, in a sense, the two ends of the magazine can be closed or open. In filling the magazine, the closing element at the lower end region is brought into the locked position so that the inserted plastic holders cannot exit again at the lower end of the magazine. The locking arrangement at the upper end of the magazine can be brought into the closed position after complete filling of a magazine, so that the plastic holders cannot fall out on that side during handling and possible mishandling of the magazine. Because the closing elements are preferably arranged at the open side of the C-shaped profile so that they extend into the displacement region of the tubular extensions of the plastic holders which are being used, there is needed no complicated arrangement of guides for sliding in the closing elements in the vicinity of the relatively narrow supply channel, but the closing elements can be located on the outer surface of the C-shaped profile which forms the magazine. The closing elements therefore slide in a region outside the opening of the C-shaped profile. Therefore in practice the projecting tubular extensions of the plastic holders are prevented from sliding further toward the end regions of the magazine. By these means it is also possible in simple manner to render the magazine ready for use by following the attachment of the magazine to the apparatus in simple manner with pulling of the appropriate closing elements into the open position.

A preferred construction provides that the closing elements are slidably displaceable transversely to the length-wise dimension of the profile into the locked and open positions. This also assures very simple operation which also functions trouble free when used during rough building site operations.

Especially through these measures it becomes particularly advantageous if the magazine is connectable directly to an individual picking device formed on or adjacent to the apparatus. In this way, only short spaces between the magazine and the individual picking device need to be bridged so that the supply of the plastic holders can take place without any problem.

For supplying of the plastic holders and their further guidance to the screwing in location it is preferred to have the magazine formed by a straight profile, with the magazine forming an acute angle with the screwing direction at the point of its attachment to the apparatus. By using a straight profile, not only the transportation of several such magazines is free of problems, but also there becomes possible the sliding of the plastic holders in such a magazine without problems or difficulty. When the attachment of the magazine to the screwing in direction of the system takes place at an acute angle, then a substantially reduced change in the position of the plastic holders is needed in order to bring these into the screwing in position, so that a directional change from the supply direction within the magazine to the screwing in position becomes possible using substantially reduced angular changes.

Exemplary embodiments of the invention are further described in the description which follows with reference to the drawings. There is shown in:

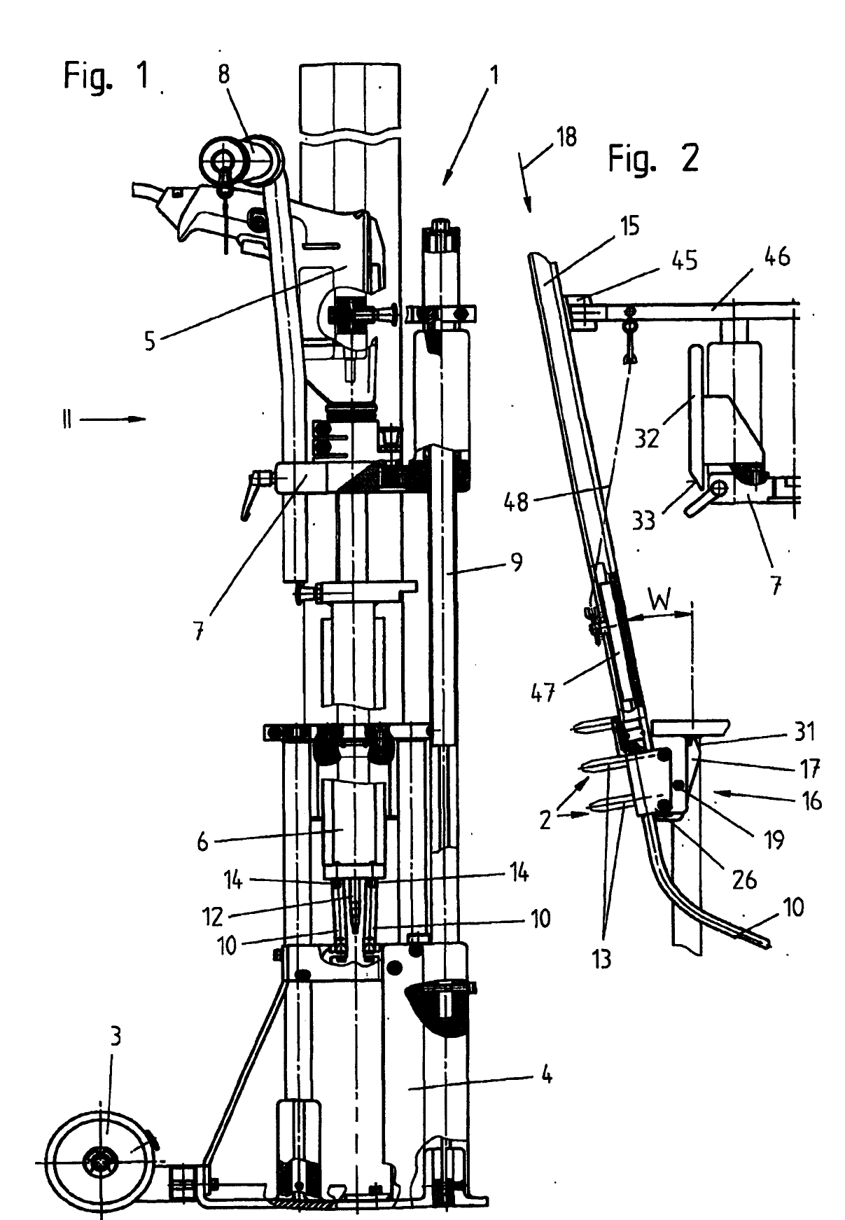

FIG. 1 a side view of an apparatus for screwing in magazine-stored prepared fastening elements, illustrated partly in cross section;

FIG. 2 a side view of a part of the apparatus of FIG. 1, viewed in the direction of arrow II;

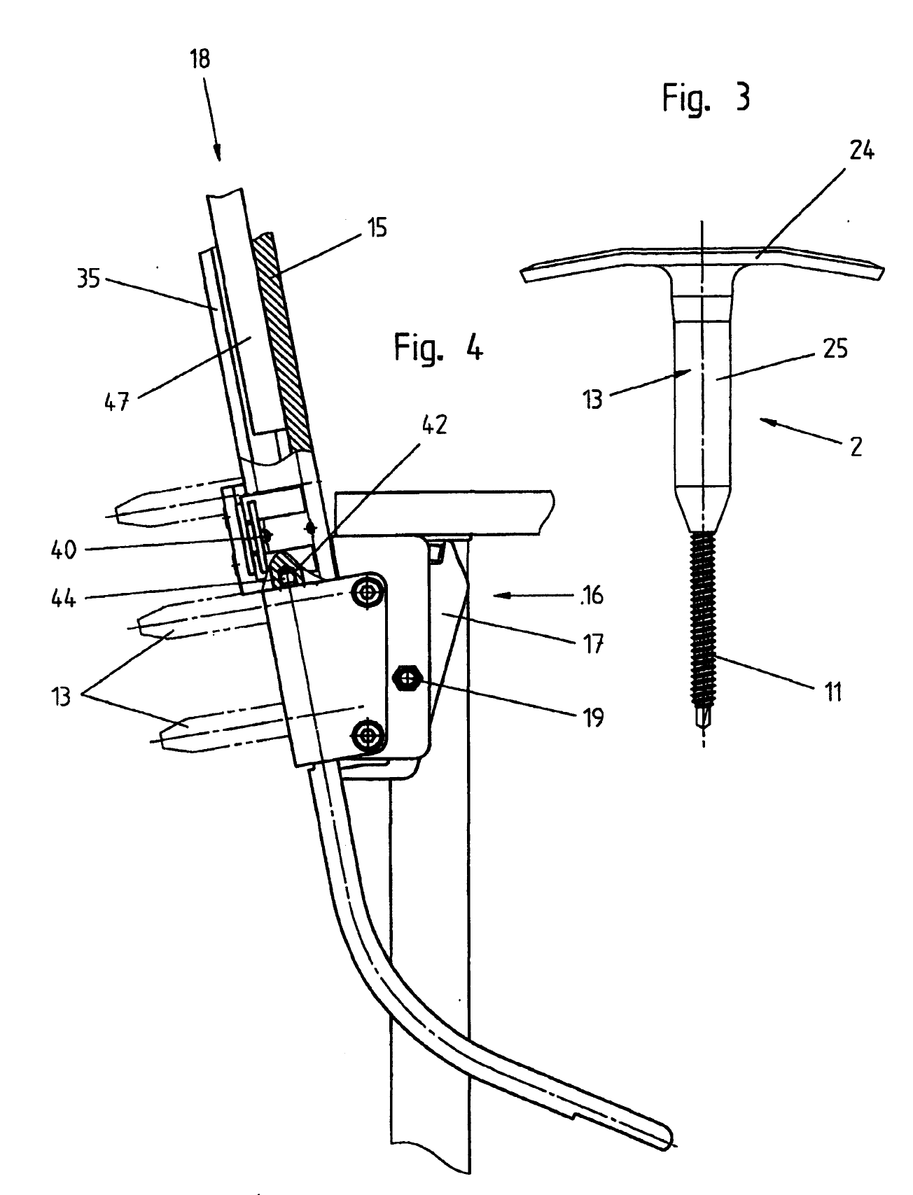

FIG. 3 a view of a fastening element usable in the apparatus, consisting of a plastic holder and a screw;

FIG. 4 an enlarged showing of an individual picking device for fastening elements supplied via a magazine;

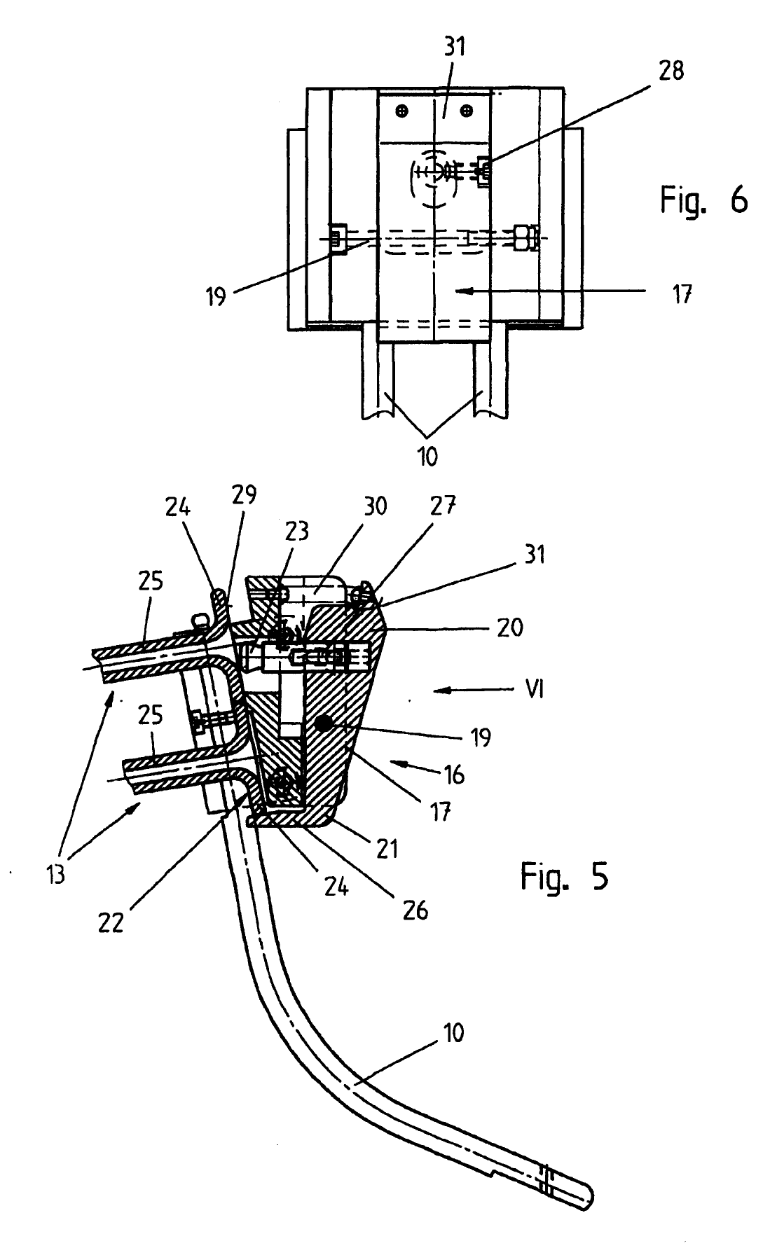

FIG. 5 a vertical cross section through the individual picking device of FIG. 4;

FIG. 6 the individual picking device viewed in the direction of arrow VI in FIG. 5;

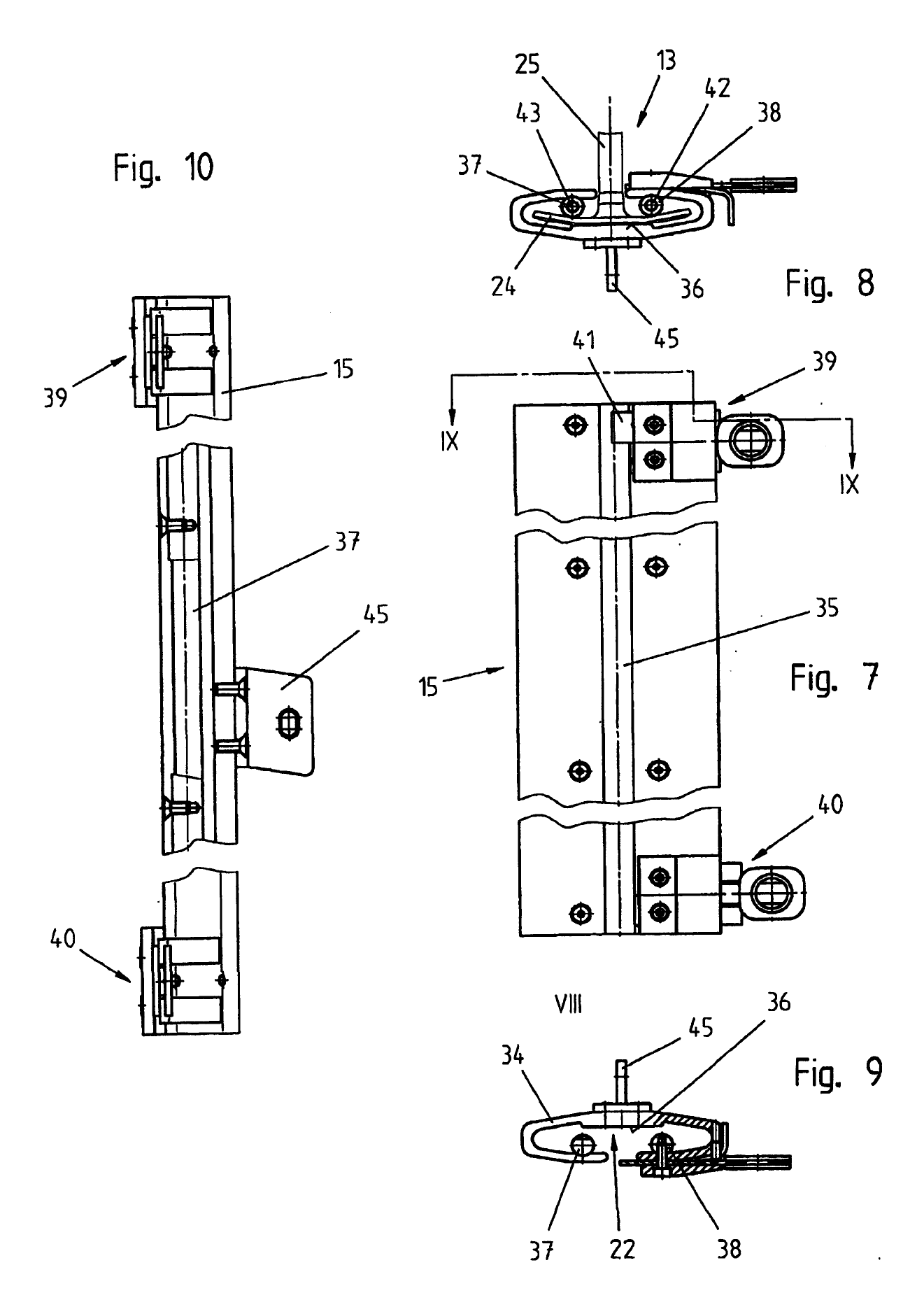

FIG. 7 a front view of the magazine;

FIG. 8 a top view of the magazine viewed in the direction of arrow VI in FIG. 7;

FIG. 9 a view in cross section along line VII-VII in FIG. 7;

FIG. 10 a side view of the magazine shown partially sectioned.

In an apparatus 1 for screwing in fastening elements 2 prepared and stored in a magazine, there is provided a base frame 4 wheelable by means of wheels 3 in which there is retained slidably in a vertical direction a screwing device 6 with an integrated screwdriver 5. The whole screwing device 6 is contained in a mounting part 7 and can therefore be handled via hand grips and by an operator. The mounting part 7 is slidably retained via appropriate guide rods, with the entire screwing device being repeatedly self-displaced into the upper rest position by means of a gas spring 9.

The fastening elements 2 are brought into the screwing in position via supply elements 10.

By pushing down the screwing device 6 a spike 12 provided with a clamp for a screw 11 penetrates far enough into the opening of a plastic holder 13 of fastening element 2 so that the clamp is grasped by the screw head. By means of appropriate bolts 14 it is achieved that during the pushing down of the fastening element 2 and during the screwing in process itself the plastic holder 13 can not turn.

As can be seen from FIG. 3, by means of such an apparatus 1, there are set fastening elements 2 which consist of the plastic holder 13 and a previously mounted screw 11. Of course it would also be possible to supply the screw 11 only after the individually picked plastic holder 13 lies in the screwing in position. However, especially with such attaching elements of plastic holder and screw it is preferable and also logical for a rapid setting process, if the screw 11 is already premounted in the plastic holder 13 and can also be supplied via a preexisting magazine 15 in that form. Between the magazine 15 and the supply elements 10, which guide the plastic holder 13 in the direction of the screwing in position, there is provided an individual picking device 16, which makes sure that, in each setting process, i.e. for each pushing down of the screwing device 6, a fastening element 2 is freed up each time and carried into the screwing in position. The picking device 16 has a lever 17 which is swivelable around an axis 19 which extends transversely to the supply direction 18 of the magazine. The end regions of both arms 20, 21 of the lever 17 engage, alternately and sometimes also simultaneously, the supply channel 22 for the plastic holder 13. The lever arm which comes first in the supply direction 18 of the plastic holders 13 has, at its free end region, a spring loaded backward-pushable abutment part 23. The picking device 16 is used especially advantageously with attaching elements which have plastic holders 13 consisting of a large surface washer 24 and a tubular extension 25.

As can be seen from the plastic holders 13 shown in FIG. 5, these are supplied to a magazine 15 in such manner that the large surface washers thereof are arranged following each other lying practically in one plane, so that the tubular extensions 25 are then also oriented substantially perpendicularly to the guide track 22 of the magazine 15.

In the picking device 16 the lever arm 21 which lies to the rear in the supply direction 18 of the plastic holders 13, is provided with an extension 26, which closes the supply channel 22 for the magazine-stored supplied plastic holders 13, in the spring loaded rest position of lever 17.

In the illustrated embodiment the spring loaded, backward-pushable abutment part 23, spring loaded bolt slidable outwardly into its rest position. Thus, there is involved a very simple construction of this abutment part 23. It is also possible that, in view of the width of lever 17, two bolts may be positioned side by side, which then jointly form the abutment part 23. With one bolt, the retention and the required spring loading is also easy to accomplish, and moreover limitation of the sliding movement of such a bolt is possible in simple manner, e.g. by means of a slot 27 and the set screw 28, which forms the abutment part 23.

As can also be seen from FIG. 5, the abutment part 23 rests with its free end oriented toward the supply channel 22 in its outwardly slid rest position until immediately before engagement in the supply channel 22. Thus, in the rest position, there is no impediment for the plastic holders 13 to continue moving forward in the supply channel 22. However, even a slight swiveling of lever 17 already causes the abutment part 23 to move in the direction of supply channel 22 and would therefore become engaged in supply channel 22 if a plastic holder 13 with large surface washer 24 is not present in precisely that location.

Upon swiveling of lever 17 the supply channel 22 is freed up by withdrawal of extension 26 so that the lowest-resting plastic holder 13 can slide downward into the screwing in position via the supply elements 10. As soon as a swiveling movement of lever 17 takes place, the abutment part 23 rests directly on the surface 29 of the next following plastic holder 13 and presses same against the opposite wall of supply channel 22. Thus this plastic holder 13 and all other plastic holders lying above it in the magazine are prevented from sliding farther downward, so that the pass-through opening of supply channel 22 which has been freed up by the extension 26 can remain open without any problems until the subsequent setting process is completed and the lever 17 can therefore be returned into its rest position.

Lever 17 is held spring loaded in its rest position and this can take place in simple manner by means of a coil spring 30. Thus, in the rest position the extension 26 of the other lever arm 21 always engages the supply channel 22.

Especially from FIG. 2—and with respect to the picking device also from FIGS. 4 and 5—it can be seen that the lever 17 has, on the side facing away from the extension 26 and from the abutment part 23, a bearing surface 31 for applying an actuating element 32 which is slidable together with the forward movement of apparatus 1. The bearing surface 31 of lever 17 and a bearing surface 33 of actuating element 32 have, in their respective rest positions, diagonal surfaces oriented parallel to each other which bear directly against each other during sliding of the screwing device 6 i.e. when sliding relative to each other, so that these bearing surfaces 31 and 33 cause a relatively rapid switching movement by lever 17.

As can be seen from the drawings, in the illustrated embodiment the picking device is located directly adjacent to the attachable magazine 15 for prestorage of plastic holders 13 and therefore directly ahead of the supply elements 10 connected thereto, which transport the plastic holders 13 into the screwing in position. In the illustrated structure, this appears to be the simplest, fastest and trouble free operating configuration. Of course, it would also be possible to provide the picking device 16 at a different location in apparatus 1, or, for example, in the immediate vicinity of the magazine 15. The specific location of the picking device 16 at a specific place is also advantageous because this enables the magazine 15 itself to have a simple structure so that fundamentally it is also possible to provide several filled magazines, which can then be attached simply one after another, in order to individually pick the prestored fastening elements 2.

The spacing between the extension 26 and the abutment part 23 is so chosen that a displacement movement of lever 17 causes the abutment part 23 to bear with appropriate spring loading against the inwardly curved part of plastic holder 13, so that the plastic holder 13 present in the second position becomes urged in the direction of extension 26. When the extension 26 then exits from the supply channel 22, i.e. when the lowest plastic holder 13 is freed up, then the spring loading of the bearing part 23 causes an intermittent farther movement of the next following plastic holder 13, because the bearing part 23 can suddenly penetrate into the center portion of the next following plastic holder 13. The lowest-positioned plastic holder 13 therefore experiences an almost blow-like, or at least a shove-like movement, thereby further effecting reliable pushing out of the freed up plastic holder 13. Upon reverse swiveling of lever 17 the extension 26 then reaches a locking position in supply channel 22, before the bearing part 23 frees up the plastic holder 13 which is now the lowest.

In the embodiment shown in FIGS. 7 to 10 there is involved in substance the specific configuration and arrangement of magazine 15. The magazine 15 serves for the positionally correct holding and slidable reception of the plastic holders 13, an essential criterion being that the large surface washers 24 of the plastic holders 13 are held within the magazine 15 following each other and practically in one plane and do not overlap with each other. This also yields a significantly thinner construction for the magazine 15, itself, and picking of the individual plastic holders 13 upon their withdrawal from magazine 15 becomes simpler.

The magazine 15 is essentially formed as a C-shaped profile 34, so that there remains free an open area 35 similar to a slot, which serves for the passage of extensions 25 of the plastic holders 13. In the interior of the profile 34 there is provided a guide rod 36 which is formed in essence by a thickened shaping of the rear wall of profile 34. Also formed or positioned in this profile 34 are guide rails 37 and 38, whereby there are formed two guides for the introduced plastic holder 13 spaced from each other on both sides of the open area 35.

By means of the guide rod 36 and the guide rails 37 and 38 there is provided in practice a supply channel 22 for the guided reception of the large surface washers 24 of the plastic holders 13 which corresponds substantially to the thickness of the washers 24. Outside, namely beside the guide rod 36 and the guide rails 37 and 38, there is sufficient space so that there exists only a very small contact area between the magazine 15 and the introduced plastic holders 13. This also ensures a very simple and trouble free follow-on sliding of plastic holders 13 during continuing withdrawal.

As can be seen especially from FIGS. 7 to 10, the magazine 15 has closing elements 39 and 40 at its two end regions, in order to effect loss-free holding of the supplied plastic holders 13. The closing elements 39 and 40 are advantageously useable, for example, during the magazine storage phase and retention of magazines 15 already equipped with plastic holders 13. This assures that the magazine-stored plastic holders 13 do not leave the magazine 15. Also, during attaching of the magazine 15 to the apparatus 1, itself, this creates no problems because the closing element can be moved into the open position after attachment of the magazine 15 to the apparatus 1.

This becomes possible because the closing elements 39, 40 can be brought into the closed and the open position transversely to the lengthwise dimension of the profile 34. A preferred construction involves, as can also be seen from FIGS. 7 to 10, locating the closing elements 39, 40 on the open side of the C-shaped profile 34, so that the closing elements 39, 40 were engaged with suitable bolts 41 in the displacement region of the tubular extensions 25 of the plastic holders 13 which are being used.

An especially desirable structure of magazine 17 is to have the free lower end of the magazine 15 attachable to the apparatus 1 in interlocking manner and have it adapted to be locked to same in non-positive manner. This makes it possible in simple manner to equip the magazine 15 with appropriate plastic holders 13 outside the apparatus 1 and when needed attach it rapidly and simply to the apparatus 1. In the illustrated example, a kind of peg-and-hole connection between the magazine 15 and the apparatus 1 is provided. In so doing holes 42, 43 are provided at the free lower end of guide rails 37, 38, which are shaped to conform to bolts 44 which are formed on apparatus 1 or preferably on a picking device 16 provided on apparatus 1. Thus the magazine 15 must only be applied to apparatus 1 in the supply direction 18 and in special cases to the picking device 16, so that the bolts 44 engage the holes 42, 43. This assures secure positioning and anti-rotation security for the magazine 15 relative to apparatus 1. In order to properly hold the magazine 15 in this initial position, an additional positive bolting to the apparatus 1 is needed. This can be achieved in simple manner by means of an attachment latch 45 located on the back of the magazine 15. Via this attachment latch 45 there is formed a connection with a bearing arm 46 which is located at the fixed base frame 4 of apparatus 1. The bolting itself takes place by means of an insertable bolt which may be spring loaded.

There are various ways to provide a mutually positive connection between the magazine 15 and the apparatus 1. Instead of a peg-and-hole connection there can be provided any kind of recesses or projections at the free end of magazine 15 with corresponding projections and recesses on apparatus 1. It is also possible to provide these projections, recesses, holes or pegs not only on the guide rod or on the guide rails, but also on the profile itself. Therefore, it is basically also possible to make a part of the profile 34 so that it protrudes, in which case an appropriate opening is formed on apparatus 1 for sliding in of the protruding part of the profile 34. Also, for the upper retainer of magazine 15, there could be provided a kind of resilient holding jaw in place of the attaching latch 45, so that the magazine would be brought into interlocking relation with the apparatus 1 only at its lower end and then be pressed with a slight twisting movement into a resilient holder. Thus the most diverse variants are available.

As can be seen from the drawings, the magazine 15 is formed by a straight profile 34. Within the inventive concept it is also possible to provide this profile 34 with an appropriate curvature, but the handling, the simple and secure supply of the plastic holders and also the attachment to the apparatus itself works better and more simply if a straight profile 34 is used. It is also preferred that the magazine 15, in its mounted position on apparatus 1, forms an acute angle W with the screwing in direction. This not only makes the handling and positioning of the magazine very simple, but the supply of the applied plastic holders 13 is also simpler because a smaller angular change is needed to reach the ultimate screwing position.

The inventive measures not only create the possibility of providing a structurally simple embodiment, but there can then also be kept ready several filled magazines which can be attached to the apparatus 1 one after the other simply and especially rapidly.

As can be seen particularly from FIGS. 2 and 4, additional advancing pressure can be obtained for the plastic holders 13 inserted in magazine 15 if a sliding body 47 also inserted in magazine 15 is used as a weight. This body 47 can be attached so that it can not be lost, for example by a chain 48 attached to the support arm 46.

1. Apparatus for screwing in magazine-fed fastening elements, which consist of a large area washer and plastic holder formed by a tubular extension and optionally a pre-mounted screw, wherein there is provided between the magazine for the plastic holders and the supply elements for the screwing-in location an individual picking device, wherein the picking device has a two-armed lever swiveable around an axis transverse to the supply direction of the magazine and wherein the lever arm which lies in the rear with respect to the supply direction of the plastic holders has in the rest position of the lever, an extension which locks the supply channel for the magazine-fed plastic holders,
characterized in that the lever arm (20) which is positioned first in the supply direction (18) of the plastic holders (13) has at its free end region a spring loaded retractable abutting portion (23) which then engages the supply channel (22) for the plastic holders (13), when the extension (26) of the rearwardly positioned lever arm (21) is moved out of its locking rest position.

2. Apparatus according to claim 1 characterized in that the spring loaded rearwardly pushable abutment (23) of the one lever arm (20) takes the form of a spring loaded bolt slidable outwardly into its rest position.

3. Apparatus according to claim 1, characterized in that the abutment (23) lies directly before the extension into the supply channel (22) with its free end oriented toward the supply channel in its pushed outwardly rest position, so that this abutment (23) promptly engages the supply channel even upon only a slight swiveling movement of the lever (17).

4. Apparatus according to claim 1, characterized in that the spacing between the fixed extension (26) and the spring loaded outwardly slidable abutment (23) is larger than the width of the large area washer (24) of the plastic holder (13) in the supply direction (18) of the supply channel (22), so that at the start of switching movement of the lever (17) and as long as the extension (26) at the other lever arm (21) frees up the passage in supply channel (22) the abutment (23) presses against the upper surface (29) of the next following plastic holder (13).

5. Apparatus according to claim 1 characterized in that the abutment (23) is shaped rounded and/or beveled at its free end.

6. Apparatus according to claim 1, characterized in that the lever (17) is held spring loaded in its rest position in which the extension (26) on the lever arm (21) located to the rear in the supply direction engages the supply channel (22).

7. Apparatus according to one of claims 1 to 6 claim 1, characterized in that the lever (17) has a bearing surface (31) on a side facing away from the extension (26) and the abutment (23) for applying an actuating element (32) which is slidable together with the advance of the apparatus (1).

8. Apparatus according to claim 7, characterized in that the application surface (31) of lever (17) and an application surface (33) of the actuating element (32), in their respective rest positions have diagonal surfaces oriented parallel to each other, which directly contact each other when sliding relative to each other.

9. Apparatus according to claim 1, characterized in that a magazine (15) for the prestorage of plastic holders (13) is attachable to the individual picking device (16).

10. Apparatus according to claim 1, in which a large surface washer and tubular extension formed from a plastic holder and an optionally preassembled screw, wherein there is provided a magazine for the correctly positioned retention and slidable reception of the plastic holders with the tubular extensions, wherein the magazine is formed as a C-shaped profile, in which there is formed the open region for passage of the extensions of the plastic holders and wherein there is formed in the interior of the profile a supply channel for the guided reception of the large area washers of the plastic holders matching the thickness of the washer of the plastic holders to be received, characterized in that the supply channel (22) in the interior of the profile (34) is bounded by a guide rod (36) and by means of guide rails (37, 38), the guide rails (37, 38) being located spaced apart on both sides of the open region (36).

11. Apparatus according to claim 10, characterized in that the guide rod (36) is formed as a reinforced configuration of the rear wall of the profile (34).

12. Apparatus according to claim 10, characterized in that the profile (34) which forms magazine (15) is attachable in plug-in or lockable form to apparatus (1).

13. Apparatus according to claim 3 characterized in that there are formed depressions or protrusions on the guide rod (36) or on the guide rails (37, 38) which are shaped to match projections or recesses on apparatus (1).

14. Apparatus according to claim 12, characterized in that, for positional security assurance and positive locking between magazine (15) and apparatus (1) there is provided on the back of the magazine (15) an attachment latch (45) for application and positive locking to the apparatus (1).

15. Apparatus according to claim 10, characterized in that the magazine (15) has at both its end regions closing elements (39, 40) for the loss-preventing retention of inserted plastic holders (13).

16. Apparatus according to claims 15 characterized in that the closing elements (39, 40) are adapted to be slidable transversely to the lengthwise direction of the profile (34) into a locking and an open position.

17. Apparatus according to claim 1, characterized in that the magazine (15) is adapted to be attached directly to an individual picking device (16) formed on the apparatus (1) or applied to same.

18. Apparatus according to claim 10, characterized in that the magazine (15) is formed by a straight profile (34), with the magazine (15) forming, when assembled with the apparatus (1), an acute angle (W) with the screwing in direction.
